(19) United States
(12) Patent Application Publication
(10) Pub. No.: US 2006/0180763 A1
(43) Pub. Date: Aug. 17, 2006

(54) Gas detector that uses infrared light and method of detecting gas concentration

(75) Inventors: Takahiko Yoshida, Okazaki-city (JP); Yasuaki Makino, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/334,458

(22) Filed: Jan. 19, 2006

(30) Foreign Application Priority Data
Feb. 14, 2005 (JP) 2005-036711

(51) Int. Cl. G01J 5/02

(52) U.S. Cl. 250/343

(57) ABSTRACT

An infrared gas detector includes an infrared light source emitting infrared light of a specific wavelength, an infrared sensor detecting the infrared light from the infrared light source, and a gas cell accommodating the infrared light source and the infrared sensor. The infrared light source contains an LED or a semiconductor laser. Since the wavelength of the infrared light from the infrared light source is specific, the energy efficiency is high. The LED and the semiconductor laser are small devices, and therefore, the infrared light source and the infrared sensor are easily accommodated in the same small package.

### CROSS REFERENCE TO RELATED APPLICATION

This application is based upon, claims the benefit of priority of, and incorporates by reference the contents of Japanese Patent Application No. 2005-036711 filed on Feb. 14, 2005.

### FIELD OF THE INVENTION

The present invention relates to a gas detector that uses infrared light and a method of detecting gas concentration. Specifically the present invention relates to an infrared gas detector that uses an infrared light source to emit infrared light and an infrared sensor that detects the concentration of a target gas by using light absorption characteristics that are determined when the infrared light propagates through the target gas.

### BACKGROUND OF THE INVENTION

For example, JP-A-2001-228086 discloses an infrared gas detector, which contains an infrared light source and an infrared sensor detecting infrared light and detects the concentration of a target gas by irradiating the gas with infrared light for detecting the absorption characteristics of infrared light.

FIG. 4 shows a schematic cross-sectional view of the infrared gas detector disclosed in the above publication. The infrared gas detector 90 is a Non-Dispersive InfraRed (NDIR) gas analyzer which, using a phenomenon by which the wavelength of the infrared light absorbed by the class of gas differs, measures the gas concentration by irradiating the gas with infrared light for detecting the absorption characteristics of infrared light at a desired wavelength.

The infrared gas detector 90 primarily contains a gas cell 2 to which a target gas to be measured is supplied, a light source 3 located inside the gas cell 2, a multi-wavelength selection filter 4, which permits infrared light of different wavelengths to pass, and an infrared sensor 5 in which the infrared sensing elements 5a and 5b are formed. The multi-wavelength selection filter 4 and the infrared sensor 5 are arranged to be mutually opposite with a broadband band pass filter 6 located therebetween. The broadband band pass filter 6 and the infrared sensor 5 are integrally packaged. The infrared sensor 5 is fixed to the gas cell 2. The multi-wavelength selection filter 4 is provided with a fine control screw 7, and by turning the screw 7, the position of the filter 4 with respect to the infrared sensor 5 is finely adjusted.

As the light source 3 for irradiating infrared light, a heat source, such as an incandescent electric bulb with a broad radiation wavelength, is used in the conventional infrared gas detector 90.

FIG. 5 is a graph showing an example of the luminescence wavelength distribution from the heat source (incandescent electric bulb), and is computed from the displacement rule of Vienna and the relation between blackbody radiation, a wavelength and temperature in a case in which the highest temperature of the light source (filament) is 690 degrees Celsius. As shown in FIG. 5, the light from the heat source (incandescent electric bulb) has a continuous large radiation wavelength band.

In the infrared gas detector 90 of FIG. 4, the infrared sensor 5 and the multi-wavelength selection filter 4 are placed oppositely, infrared light having a plurality of wavelengths determined by the relative positions of the infrared sensing elements 5a and 5b and the multi-wavelength selection filter 4 is transmitted, and the infrared sensor 5 detects the absorption characteristics of the infrared light at a desired wavelength. Therefore, the infrared gas detector 90 of FIG. 4 is suitable for detection of gas covering an unspecified variety.

However, in the case of the above structure, the multi-wavelength selection filter 4 is used, and thus the detector is relatively large. Moreover, since the infrared light source 3 always emits light having a continuous broad radiation wavelength that includes a wavelength band outside the detection range, the device is inefficient. Therefore, it is not suitable when gas to be measured is restricted to a specific gas.

### SUMMARY OF THE INVENTION

In view of the foregoing, it is an object of the present invention to provide an infrared gas detector that is relatively small.

Another object of the present invention is to provide an efficient infrared gas detector.

Still another object of the present invention is to provide a gas detector that is suitable when the gas to be measured is restricted to a specific gas.

An infrared gas detector according to a first aspect of the invention includes an infrared light source emitting infrared light of a specific wavelength, i.e., a narrow radiation wavelength band, an infrared sensor detecting the infrared light emitted from the infrared light source, and a gas cell accommodating the infrared light source and the infrared sensor therein.

Since the infrared light emitted from the infrared light source has the specific wavelength, i.e., a narrow radiation wavelength band, the energy efficiency is improved as compared with the conventional infrared gas detector that uses the incandescent electric bulb as the infrared light source.

According to a second aspect, the invention is characterized by using a light-emitting diode (LED) or a semiconductor laser as the infrared light source. An LED and a semiconductor laser are light emitting elements with a narrow radiation wavelength band. Moreover, the LED and the semiconductor laser are small light emitting elements, and therefore, the infrared light source and the infrared sensor may be easily accommodated in the same package, i.e., gas cell, and the infrared gas detector may be miniaturized.

According to a third aspect, the invention is characterized by using, as the infrared light source, a light-emitting diode (LED) or a semiconductor laser that has a narrow radiation wavelength band substantially coincident with a wavelength region that is absorbed by a target gas to be measured. Such an infrared gas detector is suitable when the target gas to be measured is restricted to a specific gas. Furthermore, an infrared wavelength selection filter may not be necessary, which is advantageous for miniaturization.

According to a fourth aspect, the invention is characterized by using, as the infrared light source, a plurality of light-emitting diodes (LEDS) or semiconductor lasers that have infrared radiation wavelength peaks different from each other. By doing so, it is possible to measure a plurality of classes of gasses and to provide a reference light. In this case, it may be desirable to integrate or mount the plural LEDs or semiconductor lasers into single package for the purpose of miniaturization.

When a plurality of light-emitting diodes (LEDS) or semiconductor lasers for having two or more infrared radiation wavelength peaks are used, one of which may be used as the above-mentioned reference light, which is not absorbed by the measured gas. This makes it possible to monitor the luminescence intensity of the infrared light source, and a highly precise gas concentration measurement may be attained.

Moreover, when the infrared light source is structured to have two or more infrared radiation wavelength peaks, it may be preferable for a voltage applied to the infrared light source to be time-shared in order to emanate the light having different infrared radiation wavelength peaks alternately. This makes it possible for one infrared sensor to accomplish both the measurement of a plurality of classes of gasses and the measurement using the reference light.

Further, using an LED or a semiconductor laser as the infrared light source makes it possible to measure a combustible gas, since these sources infrared light at low temperature, unlike a conventional infrared gas detector that uses a heat source such as an incandescent electric bulb or a heater.

### BRIEF DESCRIPTION OF THE DRAWINGS

The above and other objects, features and advantages of the present invention will become more apparent from the following description of the preferred embodiments given with reference to the attached drawings, wherein:

FIG. 1 is a schematic cross-sectional view showing the construction of an infrared gas detector according to an exemplary embodiment;

FIG. 2A is a graph showing the relationship between wavelength and normalized luminescence intensity for various kinds of light-emitting diodes (LEDs);

FIG. 2B is a table diagram showing luminous material, luminescence peak wavelength, and luminescent color with respect to spectrum number for various LEDs in FIG. 2A;

FIG. 3A is a schematic cross-sectional view showing the construction of an infrared gas detector of a modified embodiment;

FIG. 3B is a schematic cross-sectional view showing the construction of an infrared gas detector of another modified embodiment;

FIG. 4 is a schematic cross-sectional view showing the construction of a conventional infrared gas detector; and

FIG. 5 is a graph showing an example of the luminescence wavelength distribution from a heat source (an incandescent electric bulb).

### DETAILED DESCRIPTION OF THE PREFERRED EMBODIMENT

Preferred embodiments according to the present invention will be described hereunder with reference to the accompanying drawings.

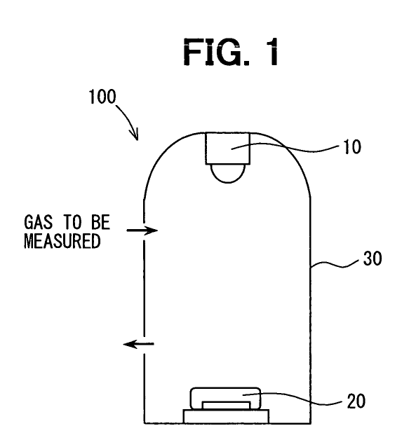

FIG. 1 is a typical sectional view showing an example of an infrared gas detector 100 according to the present invention. The infrared gas detector 100 is equipped with an infrared light source 10, which emits infrared light of a certain wavelength, and an infrared sensor 20, which detects the infrared light, in a package 30. The package 30 forms a gas cell to which a target gas to be measured is introduced, and the optical path from the infrared light source 10 to the infrared sensor 20 is defined in the package 30. The absorption degree of the infrared light while transmitting the gas to be measured is detected by the infrared sensor 20, and thus, the concentration of the gas to be measured is detected.

A light-emitting diode (LED) or a semiconductor laser is employed as the infrared light source 10 in the infrared gas detector 100. The LED and the semiconductor laser are well known as light emitting elements with a narrow radiation wavelength band, and may constitute an infrared light source that emits light of a single wavelength. Moreover, as the infrared sensor 20, a well-known semiconductor infrared sensor in which a semiconductor type infrared sensing element is formed on a semiconductor substrate may be used, for example.

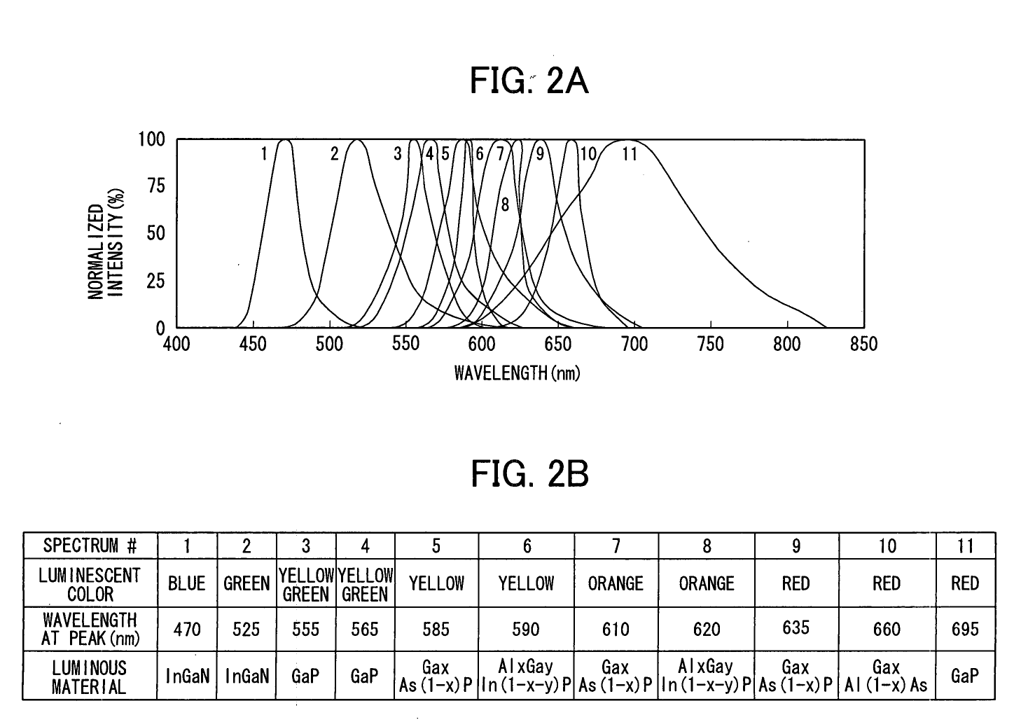

As apparent from FIGS. 2A, 2B and FIG. 5, each of the LEDs has an extremely narrow radiation wavelength band as compared with the incandescent electric bulb used as the heat source in the conventional infrared gas detector. Furthermore, the emitted light can be regulated to a specific wavelength by controlling the luminous material for constituting the LEDS.

The light from an LED is also high in directivity as compared with the light from a conventional heat source such as an incandescent electric bulb. In a case where a semiconductor laser is used as the infrared light source 10, the radiated light may be a beam that has one wavelength without variation, and therefore the directivity is sharper than that of LEDs, which have certain peak width in the radiation spectrum as shown in FIG. 2A.

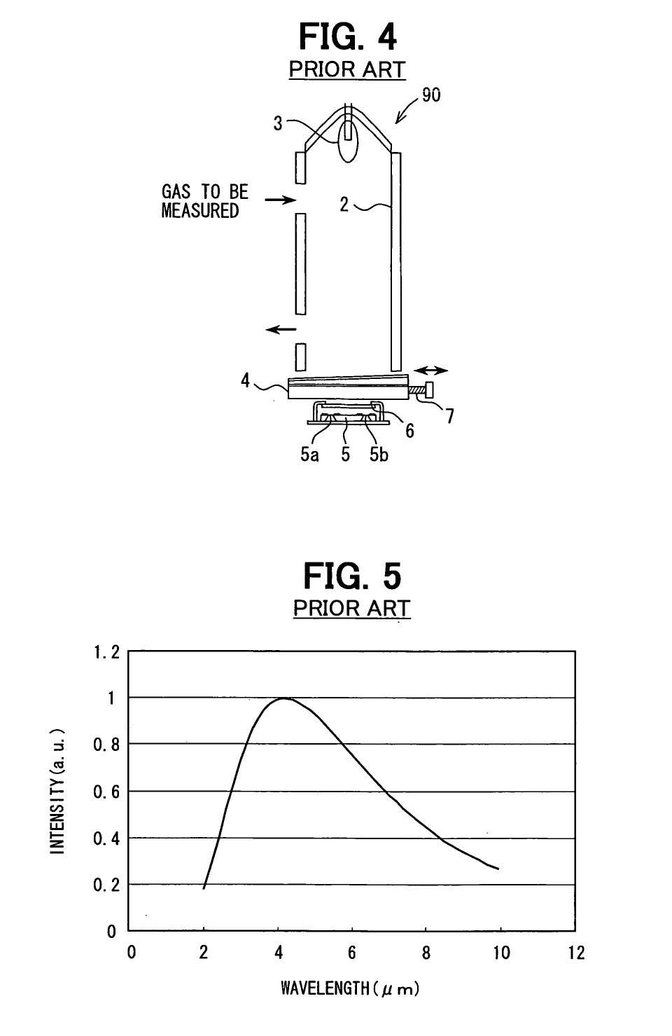

Since the infrared light emitted from the infrared light source 10, i.e., the LED or the semiconductor laser, has a narrow radiation wavelength band or a specific single wavelength, the energy efficiency is improved as compared with the conventional infrared gas detector (FIG. 4), which uses the incandescent electric bulb as the infrared light source.

Also, since the LED and the semiconductor laser are small, the infrared light source 10 and the infrared sensor 20 may be easily accommodated in the same package 30, i.e., gas cell, as shown in FIG. 1, and therefore the infrared gas detector 100 is relatively small.

Using as the infrared light source 10 the light-emitting diode (LED) or the semiconductor laser makes it possible to easily make the wavelength thereof coincident with a wavelength region that is absorbed by the measured target gas. Therefore, the infrared gas detector 100 may be suited for measuring only one class of gas, particularly for measuring a specific gas. Furthermore, the infrared wavelength selection filter 4 in FIG. 4 is not necessary, which facilitates miniaturization.

Further, using the LED or the semiconductor laser as the infrared light source 10 makes it possible to measure a combustible gas, since, unlike the light source of the conventional infrared gas detector 90 of FIG. 4, these light sources are relatively cool.

Modifications of the present invention will be described below. An infrared light source may be constituted by using a plurality of light-emitting diodes (LEDs) or semiconductor lasers that have infrared radiation wavelength peaks different from each other. By doing so, it may be possible for the infrared light source to have two or more infrared radiation wavelength peaks, which is suited to measure a plurality of classes of gasses and to measure using a reference light. In this case, it may be desirable to integrate or mount the plural LEDs or semiconductor lasers into single package for miniaturization.

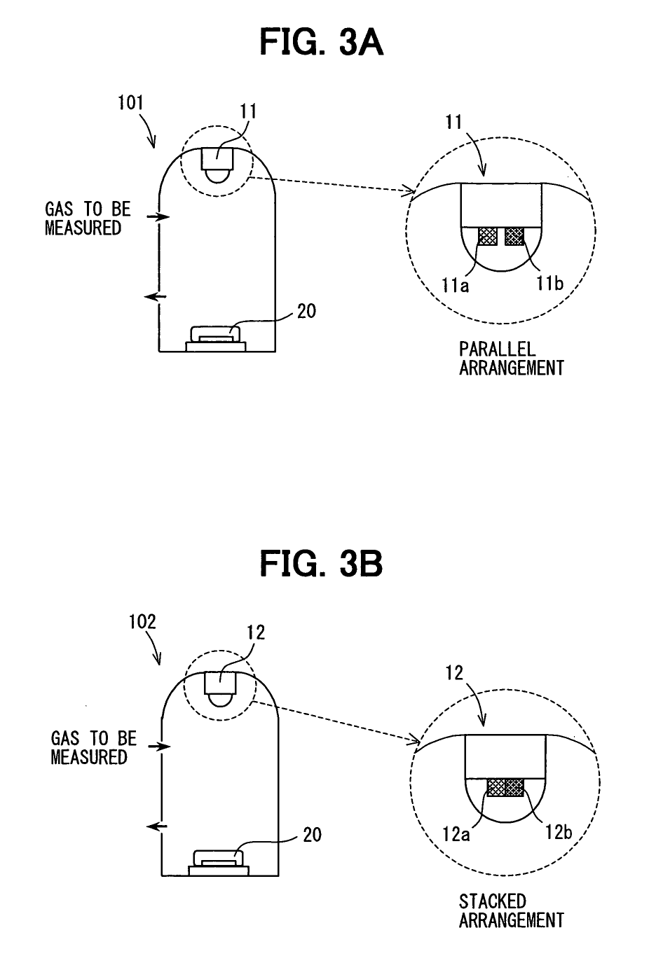

In an infrared gas detector 101 of FIG. 3A, light-emitting diodes, LEDs (or semiconductor lasers) 11a and 11b are arranged in parallel to constitute an infrared light source 11. On the other hand, in an infrared gas detector 102 of FIG. 3B, light-emitting diodes, LEDs (or semiconductor lasers) 12a and 12b are arranged in stacked configuration to constitute an infrared light source 12.

In the infrared gas detectors 101 and 102 of FIGS. 3A and 3B, the infrared light sources 11 and 12, which comprise two LEDs (or semiconductor lasers) 11a, 11b, 12a, and 12b, are collectively packaged to constitute one light source and thus, miniaturization of the infrared gas detectors 101 and 102 is attained.

As described above, in case the infrared light source 11, 12 has two or more infrared radiation wavelength peaks, the resultant infrared gas detector 101, 102 becomes suitable to measure a plurality of classes of gasses and to measure using a reference light.

That is to say, when a plurality of light-emitting diodes (LEDs) or semiconductor lasers is used for producing two or more infrared radiation wavelength peaks, one of the light sources may be used as a reference light, which is not absorbed by the measured gas. This makes it possible to monitor the luminescence intensity of the infrared light source 11, 12, and a highly precise gas concentration measurement may be achieved. On the other hand, if a plurality of classes of gasses is measured, the infrared light source 11, 12 may be structured so that the infrared light emitted from the LEDs or semiconductor lasers has wavelengths substantially coincident with wavelength regions that are absorbed by the two or more target gasses.

Moreover, when the infrared light source 11, 12 is structured to have two or more infrared radiation wavelength peaks as in FIGS. 3A, 3B, it may be preferable for a power supply, i.e., a voltage applied to the infrared light source 11, 12, i.e., the LEDs (or semiconductor lasers) 11a and 11b, 12a and 12b, to be applied alternately. By doing so, the infrared light sources 11, 12 emanate light having different infrared radiation wavelength peaks alternately. In association with this, it is preferable for the infrared sensor 20 to be constituted to synchronously detect infrared light having different infrared radiation wavelength peaks. This makes it possible for one small infrared sensor 20 to accomplish both the measurement of a plurality of classes of gasses and the measurement using the reference light.

While the invention has been described with reference to preferred embodiments thereof, it is to be understood that the invention is not limited to the preferred embodiments and constructions. The invention is intended to cover various modifications and equivalent arrangements. In addition, the various combinations and configurations, which are preferred, other combinations and configurations, including more, less or only a single element, are also within the spirit and scope of the invention.

What is claimed is:

1. An infrared gas detector comprising:
an infrared light source emitting infrared light at a certain specific wavelength;
an infrared sensor that detects the infrared light from the infrared light source; and
a package accommodating the infrared light source and the infrared sensor therein, wherein a target gas to be measured is introduced into the package, and wherein a concentration of the target gas is detected based on an absorption degree of the infrared light while the target gas is introduced into the package.

2. The infrared gas detector according to claim 1, wherein the infrared light source has an infrared emitter selected from the group consisting of a light emitting diode and a semiconductor laser.

3. The infrared gas detector according to claim 1, wherein the certain specific wavelength of the infrared light emitted from the infrared light source is controlled to be substantially coincident with a wavelength region that is absorbed by the target gas.

4. The infrared gas detector according to claim 1, wherein a space between the infrared light source and the infrared sensor is free from an infrared wavelength selection filter.

5. The infrared gas detector according to claim 1, wherein the infrared light source is structured to emit infrared light having a plurality of peaks at certain specific wavelengths that are different from each other.

6. The infrared gas detector according to claim 5, wherein one of the certain specific wavelengths is controlled to be within a wavelength band that a corresponding infrared light is not absorbed by the target gas to be measured.

7. The infrared gas detector according to claim 6, wherein the corresponding infrared light is used as a reference light in measurement.

8. The infrared gas detector according to claim 5, wherein the infrared light source is powered to emit the different wavelengths of light at different times, respectively.

9. An infrared gas detector comprising:
an infrared light source including a light emitting diode or a semiconductor laser, which emits infrared light;
an infrared sensor that detects infrared light from the infrared light source; and
a gas cell accommodating the infrared light source and the infrared sensor therein, wherein a target gas to be measured is introduced into the gas cell, and wherein a concentration of the target gas is detected based on an absorption degree of the infrared light while the target gas is introduced into the gas cell.

10. The infrared gas detector according to claim 9, wherein the infrared light emitted from the infrared light source has a wavelength controlled to be substantially coincident with a wavelength region that is absorbed by the target gas.

11. An infrared gas detector comprising:
an infrared light source including a plurality of light emitters that emit infrared light at different wavelengths, the light emitters being selected from the group consisting of a light emitting diode and a semiconductor laser;
an infrared sensor that detects infrared light from the infrared light source; and
a gas cell accommodating the infrared light source and the infrared sensor therein, wherein one or more target gasses is introduced into the gas cell, and wherein one or more concentrations of the target gasses is detected based on absorption characteristics of the infrared light while the one or more target gasses is introduced into the gas cell.

12. The infrared gas detector according to claim 11, wherein the infrared light emitted from the infrared light source has wavelengths controlled to be substantially coincident with wavelength regions that are absorbed by the target gasses, respectively.

13. The infrared gas detector according to claim 11, wherein the infrared light source produces a first light having a first wavelength controlled to be within a first wavelength region that is not absorbed by the introduced one or more target gasses, and a second light having a second wavelength controlled to be substantially coincident with a second wavelength region that is absorbed by the introduced one or more target gasses, wherein the first light is used as a reference light.

14. The infrared gas detector according to claim 11, wherein the plurality of light emitters of the infrared light source are powered to emit the infrared light of the different wavelengths alternately.

15. A method of detecting a concentration of a gas comprising:
emitting infrared light at a certain specific wavelength;
irradiating a gas with the infrared light; and
detecting a concentration of the gas based on an absorption degree of the infrared light when the infrared light irradiates the gas.

16. The method according to claim 15, wherein the gas is selected to be a specific gas.

17. The method according to claim 15, wherein the certain specific wavelength of the infrared light is determined to be substantially coincident with a wavelength region that is absorbed by the gas.

18. The method according to claim 15, wherein the gas is a combustible gas.
